(19) United States
(12) Patent Application Publication
(10) Pub. No.: US 2013/0269229 A1
(43) Pub. Date: Oct. 17, 2013

(54) Advertising Device for Crowd Guiding System

(71) Applicant: Gustavo C. Rodriguez-Aparicio, SR., Guaynabo (IT)

(72) Inventor: Gustavo C. Rodriguez-Aparicio, SR., Guaynabo (IT)

(21) Appl. No.: 12/843,442

(22) Filed: Jul. 26, 2010

Related U.S. Application Data
(63) Continuation-in-part of application No. 11/703,456, filed on Feb. 8, 2007, now abandoned.

(51) Int. Cl. G09F 7/18; G09F 7/00

(52) U.S. Cl. CPC G09F 7/18; G09F 7/00
USPC 40/600; 40/584; 40/607.13

(57) ABSTRACT

A device for advertising, display of information, personalized messages, and the like, which can be mechanically attached to a crowd guiding system, such as post and retractable belts. A flexible wall section contains displayed information, and can form three dimensional images. The wall section is removable so that other information may be displayed on the device.

### RELATED APPLICATIONS

The present application is a Continuation-In-Part of U.S. patent application Ser. No. 11/703,456 filed on Feb. 8, 2007.

### STATEMENT REGARDING FEDERALLY SPONSORED RESEARCH AND DEVELOPMENT

N/A

### BACKGROUND OF THE INVENTION

1. Field of the Invention

The present invention relates to an advertising device for crowd guiding systems, and more particularly to a display device adapted to have advertising images disposed thereon and which can be readily affixed to crowd guiding systems, such as post with extensible belts or velvet tubes.

2. Discussion of the Background

The posts for crowd control are located in high traffic areas. With our device, mini-billboards that hang either from the posts or envelope the extensible tape between the posts, these areas are customized with advertisers' logos and messages. These mini-billboards envelope the public, which enters the universe of the advertising campaign.

People in line do not usually have anything on which to focus their attention, which leads the new media to always be noticed, reaching a level of dispersion next to zero.

And the display time for messages at a short distance is certainly greater than the other media 30 channels.

Messages may suggest methods of payment, additional services or even direct purchasing of merchandise displayed at the end or along the line by means of shelves attached to the posts. Contrary to the large panels that dominate the urban landscape and the interior of establishments, our new media is subtle.

But it has a high impact capacity, because it is spread over large areas and the public interact with it in its own sphere of action, where messages are repeated.

For example if a person is about to go into a movie theater several question leading to specific products while waiting for service in a line, such as type a credit card to use or candy to buy might come up to customer mind. With questions such as the ones above just before the point of sale we encourage patrons to increase consumption, creating the perfect call to action.

Our device has no adverse effects. The mini-billboards are a part of the separation posts that are already there, so they do not interfere with the functionality of the equipment and maintain a pleasant environment.

In addition the advertiser leaves the impression of caring about the order of that space since the media mini-billboards are part of an organization system.

Accordingly, there is a need in the art for a method needed to provide an advertising system serving as a guiding device in high traffic areas.

### SUMMARY OF THE INVENTION

To overcome the shortcomings of other advertising systems implemented in high traffic areas, a relatively small, inexpensive, disposable, mini banner for use on crowd guiding systems, such as posts with extensible belts or velvet tubes, has been developed.

Therefore, it is an object of the present invention to provide an advertising device suitable for mounting on existing people guiding systems. This device can be used for advertising, display of information, personalized messages, and the like, and can be mechanically attached to a crowd guiding system, such as post and retractable belts. A flexible mini-billboard section contains displayed information, and can form three dimensional images. The mini-billboard section is removable so that other information may be displayed on the device.

The invention, itself, however both as to its organization and its method of operation, together with further objects and advantages thereof may best be understood by reference to the description taken in connection with the accompanying drawing.

When the word “invention” is used in this specification, the word “invention” includes “inventions”, that is, the plural of “invention”. By stating “invention”, the Applicant does not in any way admit that the present application does not include more the one patentable and non-obviously distinct invention and Applicant maintains that the present application may include more than one patentably and non-obviously distinct invention. The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

FIG. 1 shows an exemplary advertising device for crowd guiding system constructed in accordance with the principles of the present invention

FIGS. 2A through 2B shows an exemplary advertising device surface for crowd guiding system constructed in accordance with the principles of the present invention.

FIGS. 3A through 3C shows an first exemplary advertising device attachment for crowd guiding system constructed in accordance with the principles of the present invention.

FIGS. 4A through 4B shows an second exemplary advertising device attachment for crowd guiding system constructed in accordance with the principles of the present invention.

FIG. 5 shows the center part of the second exemplary advertising device attachment for crowd guiding system constructed in accordance with the principles of the present invention.

FIGS. 6A through 6B shows the extended portions of the second exemplary advertising device attachment for crowd guiding system constructed in accordance with the principles of the present invention.

FIGS. 7A through 7C shows the arrangement of the second exemplary advertising device attachment for crowd guiding system constructed in accordance with the principles of the present invention.

FIGS. 8A through 8B shows the assembly of the second exemplary advertising device attachment for crowd guiding system constructed in accordance with the principles of the present invention.

FIGS. 9A through 9B shows an third exemplary advertising device attachment for crowd guiding system constructed in accordance with the principles of the present invention.

FIG. 10 show the assembly of the third exemplary advertising device attachment for crowd guiding system constructed in accordance with the principles of the present invention.

FIGS. 11A through 11C shows an fourth exemplary advertising device attachment for crowd guiding system constructed in accordance with the principles of the present invention.

FIGS. 12A through 128 shows an fifth exemplary advertising device attachment for crowd guiding system constructed in accordance with the principles of the present invention.

### DESCRIPTION OF THE PREFERRED EMBODIMENT

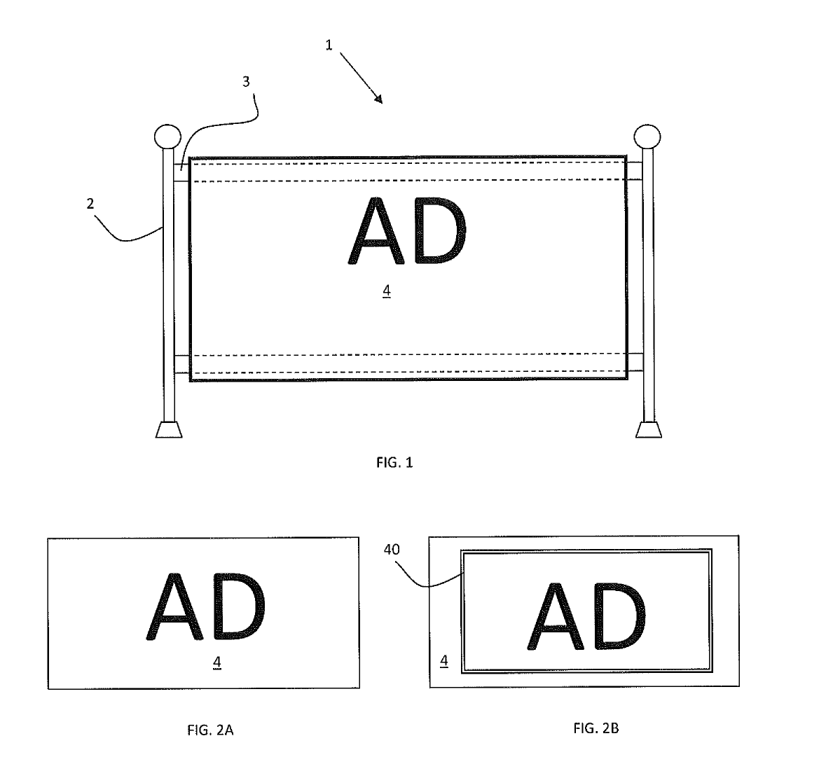

FIG. 1 shows an exemplary advertising device for crowd guiding system wherein the system comprises a set of posts 2, a belt 3 extended between the two post 2 and a advertising device 4. The advertising device 4 comprising a surface, preferably a planar surface that displays indicia, as shown in FIG. 2A. As shown in FIG. 2B, the Planar surface may have a central displaying section with a border 40 made of a florescent material in order to draw attention to the advertisement. The use of florescent material for the border may vary, for example light or any other material or device that assists with pointing out the advertisement can be employed.

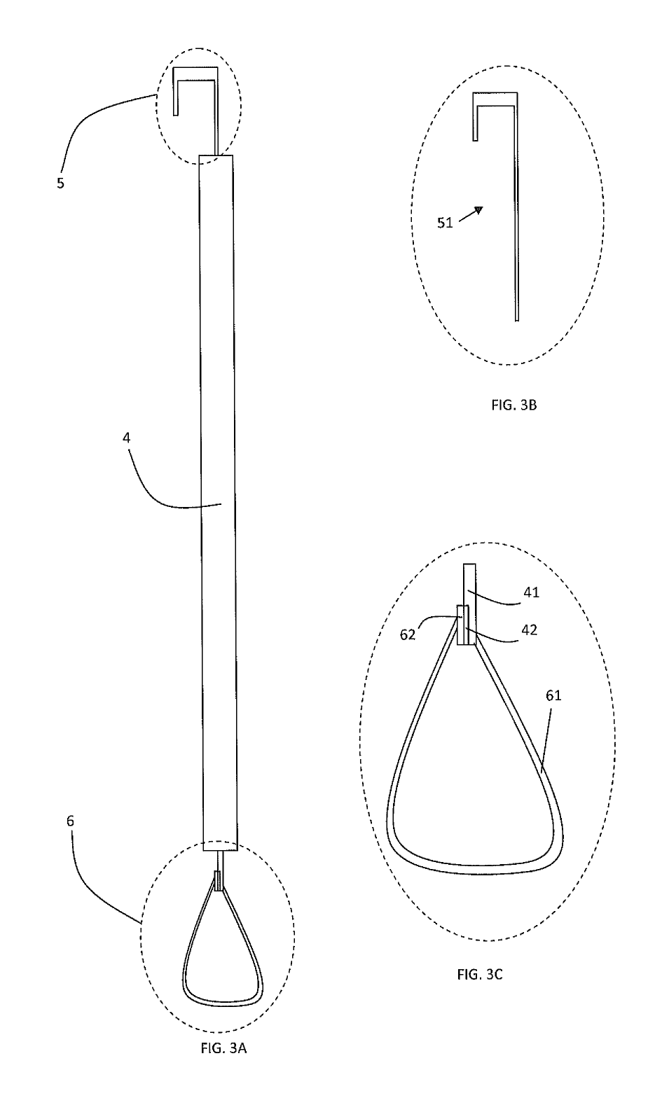

FIGS. 3A through 3B are directed to the first exemplary advertising device 4 attachment for crowd guiding system constructed in accordance with the principles of the present invention. FIG. 3A is a side view of the advertising device 4 comprising a first distal end 5 and a second distal end 6. The first distal end 5 comprises a hook piece, wherein said hook piece has a curved or concave shape. The concave shape of the hook piece 51 assists the placement of the advertising device 4 top part with the belt 3. The second distal end comprises a more flexible end. A flange 41 extending from the advertising device 4 connects a flexible body 61. The flexible body made for example of rubber is fixed on one extreme to the flange 41 and the second extreme has a attaching mean 62, such as a magnet body, wherein said magnetic body comprises a ferromagnetic material or magnet. The attaching means 62 is attached or mechanically coupled to a receiving end 42. The receiving end 42 is made of a material that connects with the attaching mean 62 in such way that creates a close loop with the flexible body 61.

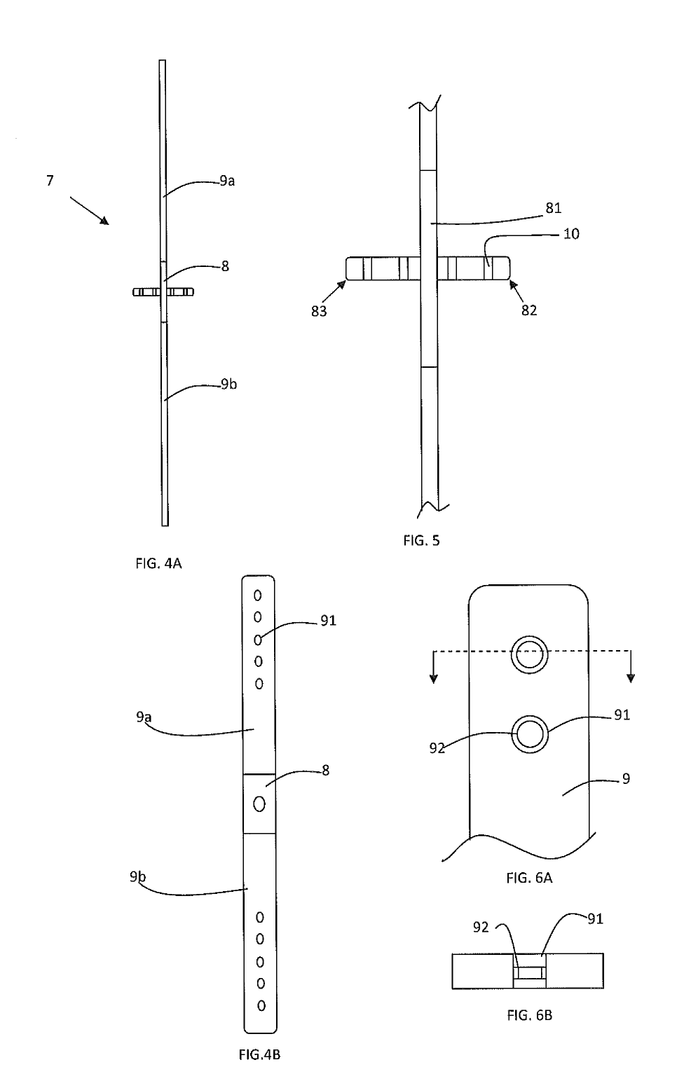

FIGS. 4A through 8B are directed to a second exemplary advertising device 4 attachment for crowd guiding system constructed in accordance with the principles of the present invention. The second exemplary comprises a first fixing part 7. The first fixing part 7 comprises a center piece 8, a first extension end 9a and a second extension end 9b. The first extension end 9a and a second extension end 9b comprise several holes 91 as shown in FIG. 4a through 4b.

FIG. 5 is directed to the center piece for the first fixing part 7. The center piece comprises a first protrusion 82 and a second protrusion 83 extended perpendicular to a planar surface that connects with the first extension end 9a and a second extension end 9b. Each protrusion comprises at least a groove 10. The center piece is preferred to have a more rigid structure compare to first extension end 9a and a second extension end 9b.

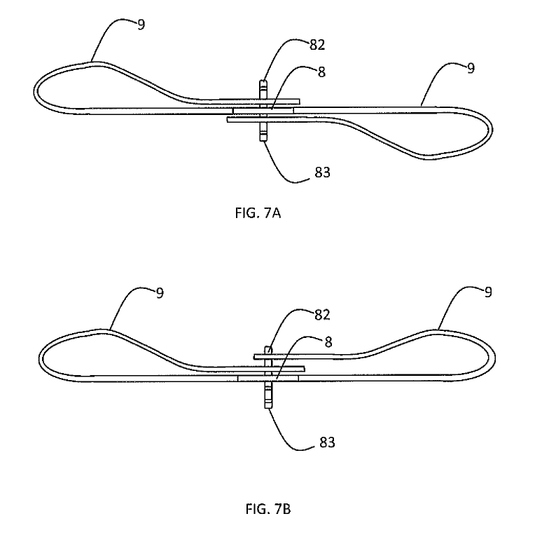

Further FIGS. 6A through 6B are directed to the first extension end 9a and a second extension end 9b, more particular to the holes 91. Each holes 91 has a projection 92, wherein the projections 92 extend toward the inside area of the hole 91.

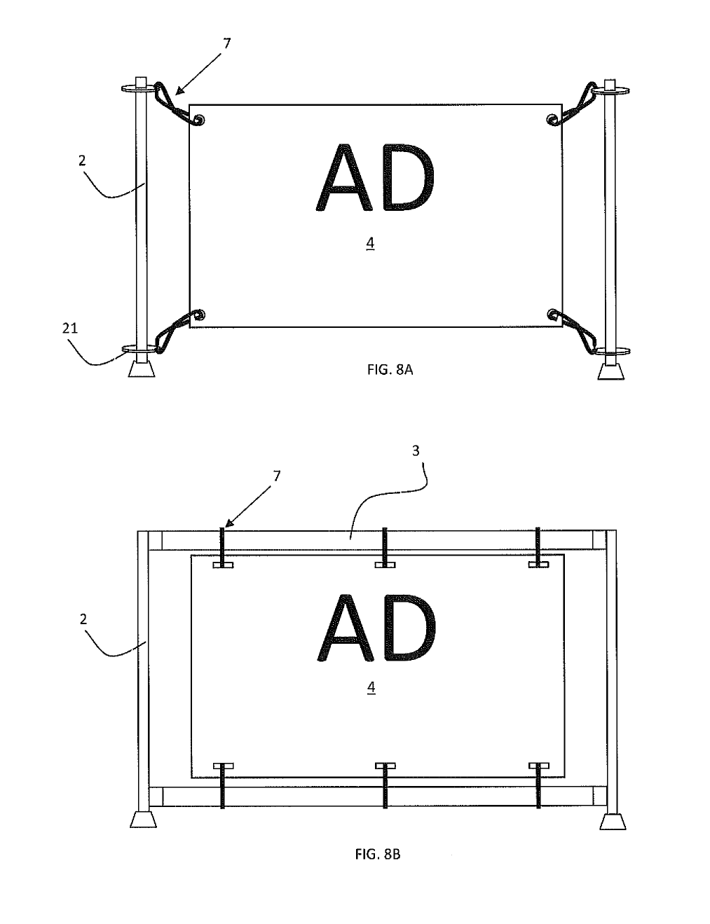

The holes 91 combined with the protrusion 82,83 provide locking means for the first fixing part 7. FIG. 7A through 7B provide an example of the first extension end 9a and a second extension end 9b bended and fixed in a pre-determinate position by inserting the protrusions 82,83 through holes 91 in such way that the projections 92 are fixed by means of grooves 10. The protrusions 82,83 are provided with at least two grooves 10 per protrusion in order to deflect the first extension end 9a and a second extension end 9b in any desired direction.

FIGS. 8A through 8B discloses the second exemplary advertising device 4 attachment for crowd guiding system constructed in accordance with the principles of the present invention using the first fixing part 7. The fixing part 7 is used to attach the advertising device 4 to the post 2 as shown in FIG. 8A or to the belt 3 as shown in FIG. 8B.

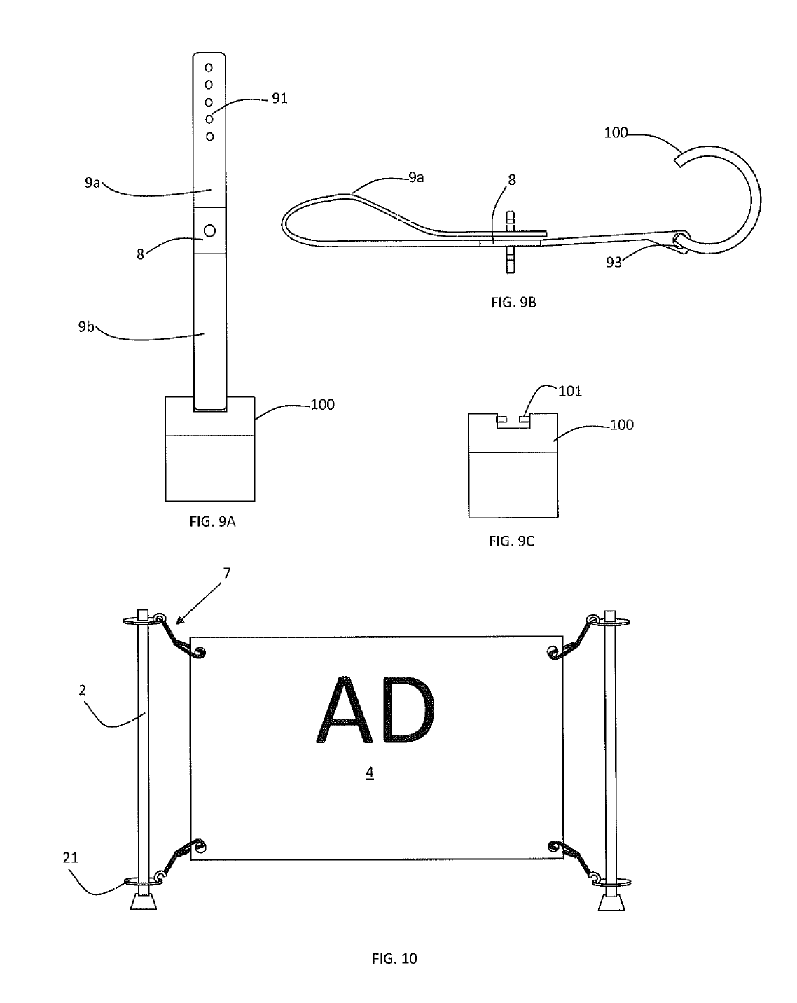

FIG. 9A through 9C are directed to a third exemplary advertising device 4 attachment for crowd guiding system constructed in accordance with the principles of the present invention. The third exemplary comprises a second fixing part 71. The second fixing part 71 comprises a center piece 8, a first extension end 9a, similar to the previous example and a second extension 9b with a fastener piece 100 at the distal end. The fastener piece 100 is configured to provide engaging means, such as a hook-like configuration and comprises a protrusion 101. The second extension end 9b comprises a channel 93 serving as holding means for the fastener piece 100. Protrusion 101 are positioned inside channel 93 serving as pivoting mechanism between second extension end 9b and fastener piece 100.

FIG. 10 shows the engagement of advertising device 4 attachment for crowd guiding system constructed in accordance with the principles of the present invention using second fixing part 71. A set of post 2 distance apart are positioned parallel to the advertising device 4. Each corner of the advertising device 4 is provided with a perforation serving to pass through for first extension end 9a. The first extension end 9a is fixed to the advertising device 4 by bending first extension end distal end and adjusting a selected hole 91 on protrusion 83 of the center piece 8. Further the second extension 9b with fastener piece 100 at the distal end is fixed to the post 2.

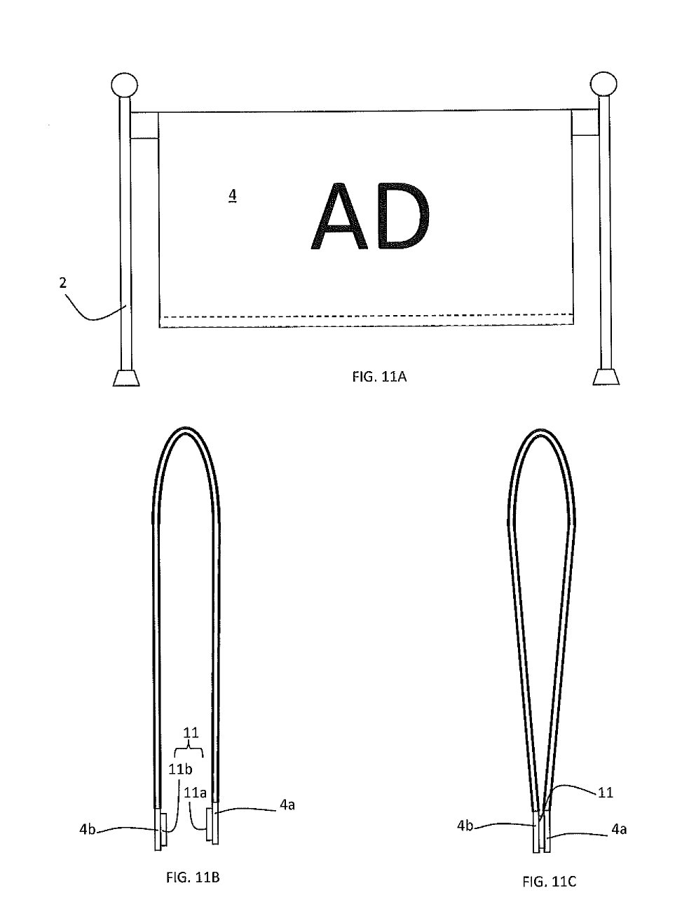

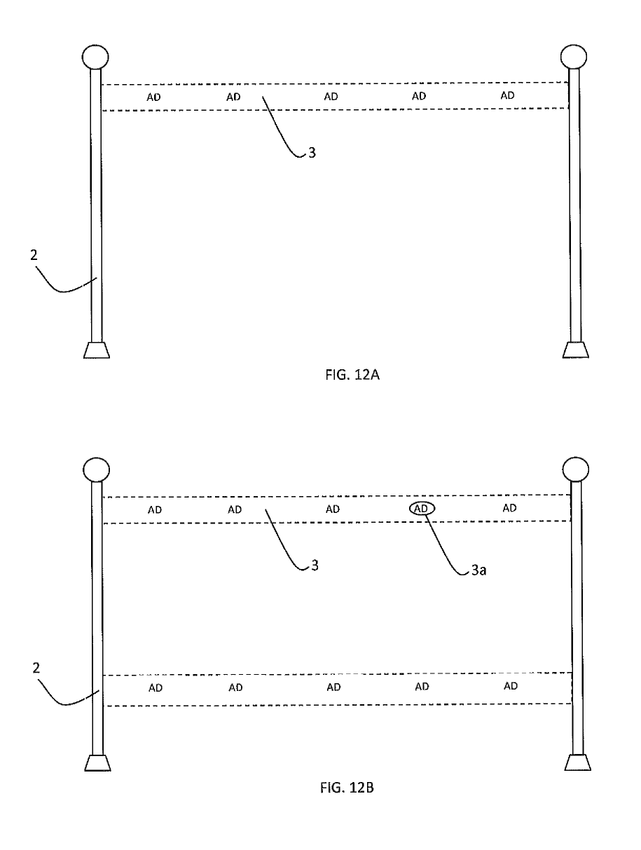

FIG. 11A through 11C are directed to a forth exemplary advertising device 4 attachment for crowd guiding system constructed in accordance with the principles of the present invention. The forth exemplary comprises an advertising device 4 having a bendable planar surface. The bendable planar surface comprises coupling means 11 located at the planar surface opposed distal ends 4a,4b. For example the first planar distal end 4a comprises a first coupling mean 11a which connect to second coupling mean 11b located at the opposed second planar distal end 4b. FIG. 11C show the connection of the first coupling mean 11a end and second coupling mean 11b. For example in order to fix the first coupling mean 11a end and second coupling mean 11b a hook-and-loop fasteners is employed.

FIG. 12A through 12B are directed to a fifth exemplary advertising device for crowd guiding system constructed in accordance with the principles of the present invention. The fifth exemplary advertising device comprises a belt 3 with indicia 3a. The belt is mark with a preferred advertisement that may be space apart.

The invention is not limited to the precise configuration described above. While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

1. An advertising device for crowd guiding system, comprising:
a plurality of posts, wherein each post is distantly apart,
a belt extended between the posts,
and a advertising device comprising a planar surface, a first distal end and a second distal end,
wherein said planar surface comprises an indicia,
wherein said first distal end comprises first attachment mean and,
wherein said second distal end comprises second attaching mean.

2. An advertising device according to claim 1, wherein said first attachment mean comprises a curved end serving as a fastening mean.

3. An advertising device according to claim 1, wherein said second attachment mean comprises a flange extending from the planar surface and an elongated flexible body.

4. An advertising device according to claim 3, wherein said elongated flexible body comprises a first extreme connected to the flange and a second extreme comprising a first fastening mean and,
wherein the flange comprises a receiving end wherein said receiving end holds the fastening mean in position when said receiving end and said fastening means are in contact.

5. An advertising device according to claim 4, wherein the fastening mean comprises a first magnetic body and the receiving end comprises a second magnetic body.

6. An advertising device according to claim 1, wherein said first attachment mean comprises a first fabric surface covered with tiny hooks and the second attachment mean comprises second fabric surface covered with tiny loops, wherein the first fabric surface holds second attachment mean when said first fabric surface and second fabric surface are in contact.

7. An advertising device according to claim 1, wherein said first attachment mean comprises fixing part comprising;
a center piece, a first extension end and a second extension end,
wherein said center piece comprises at least a protrusion and,
wherein said first extension end comprise several holes.

8. An advertising device according to claim 1, wherein said second extension end comprises several holes.

9. An advertising device according to claim 1, wherein said second extension end comprises a curved end serving as a fastening mean.
